(19) United States
(12) Patent Application Publication
(10) Pub. No.: US 2014/0295207 A1
(43) Pub. Date: Oct. 2, 2014

(54) TEXTILE STRUCTURE FOR THE REINFORCEMENT OF A POLYMER MATERIAL

(71) Applicant: NV BEKAERT SA, Zwevegem (BE)

(72) Inventors: Henk Cornelus, Avelgem (BE); Veerle Van Wassenhove, Aarsele (BE); Annelien Van Laerle, Gent (BE)

(21) Appl. No.: 14/353,216

(22) PCT Filed: Oct. 12, 2012
(86) PCT No.: PCT/EP2012/070280

§ 371 Date: Apr. 21, 2014

(30) Foreign Application Priority Data
Oct. 27, 2011 (EP) 11186883.2

(51) Int. Cl. C08J 5/04; D04B 21/16; D03D 41/00; D03D 15/02

(52) U.S. Cl. CPC C08J 5/041; D03D 15/02; D04B 21/16; D03D 41/00
USPC 428/605; 139/425 R; 66/202; 139/11; 442/172

(57) ABSTRACT

A textile structure for the reinforcement of a polymer material The invention relates to textile structure (100) for the reinforcement of a polymer material. The textile structure comprises in a first direction a number of bundles arranged in mutual substantially parallel position. The bundles comprise n metal filaments. The bundles have a main axis and a non-circular cross-section. For each of the bundles, the n metal filaments of a particular bundle are arranged predominantly parallel with the main axis of this particular bundle. The structure further comprises elongated positioning elements (106) to hold the bundles in mutual substantially parallel position and to hold the n metal filaments of a particular bundle predominantly parallel with the main axis of the bundle. The invention further relates to a method of manufacturing such a textile structure and to the use of a textile structure for the reinforcement of a polymer material.

### TECHNICAL FIELD

The invention relates to a textile structure for the reinforcement of a polymer material. The invention further relates to a method of manufacturing such a textile structure.

Furthermore the invention relates to the use of a textile structure for the reinforcement of a polymer material such as a thermosetting polymer material.

### BACKGROUND ART

Reinforcing polymer materials with glass fibers and carbon fibers is known in the art. These materials have a high stiffness and strength and are thus suitable to reinforce polymer materials such as thermoplastic and thermosetting polymer material.

However when glass fibers or carbon fibers are used to reinforce polymer material the impregnation speed (infusion speed) is low due to the low diameter of the fibres.

By using steel wires, the infusion speed is considerably improved due to the larger diameter of the steel wires (compared to the diameter of the glass or carbon fibers) and the larger voids between the steel wires. The use of metal wires to reinforce polymer material is for example known from U.S. Pat. No. 7,144,625, from U.S. Pat. No. 6,811,877 and from WO 2010/018225. U.S. Pat. No. 7,144,625 describes reinforcing structures made from metal filaments twisted together. One drawback of such structures is that the twisted filaments are not used at their full strength.

U.S. Pat. No. 6,811,877 describes the use of essentially straight parallel filaments wrapped together by a wrapping filament, more particularly a helically wound wire wrapped around the parallel filaments. The wrapping filament shares the load between the different parallel filaments.

WO 2010/018225 describes a method of manufacturing a polymer matrix reinforced with metallic elements. As metallic elements multistrand wires or metallic elements having a wrapping filament are described. In a multistrand construction wires or filaments are combined to form a strand and a number of strands are twisted, bundled or cabled to form the multistrand construction. A drawback of multistrand constructions and of metallic elements having a wrapping filament is the limited infusion or penetration of the polymer material in the metallic elements, i.e. between the individual filaments of the metallic element.

### DISCLOSURE OF INVENTION

It is an object of the present invention to provide a textile structure for the reinforcement of a polymer article, such as a wind turbine blade. It is another object of the present invention to provide a textile structure comprising mutual parallel bundles, whereby the filaments present in a bundle are in parallel position without using a wrapping filament or a binding agent.

It is another object of the present invention to provide a textile structure wherein the filaments present in a first direction of this textile structure are used at their full strength.

It is a further object of the present invention to provide a textile structure allowing high penetration of polymer during impregnation.

It is still a further object to provide a textile structure allowing an improved stacking in a multilayer structure.

According to a first aspect of the present invention a textile structure for the reinforcement of a polymer material is provided. The textile structure comprises in a first direction a number of bundles arranged in mutual substantially parallel position. Each of the bundles is having a main axis and a non-circular cross-section. More preferably, the bundles have a non-circular, convex cross-section.

Each of the bundles comprises a number of filaments. The number of filaments present in a bundle is defined as n.

The n metal filaments present in a particular bundle are arranged in a predominantly parallel position with the main axis of this bundle. The textile structure further comprises elongated positioning elements to hold the bundles in mutual parallel or mutual substantially parallel position and to hold the n metal filaments present in a particular bundle in a position that is predominantly parallel with the main axis of this bundle.

In a preferred embodiment the textile structure according to the present invention consists of n metal filaments. Preferably, the n metal filaments of a bundle are not twisted, cabled or bunched together.

It is essential for a structure according to the present invention that the different bundles are arranged in a mutual parallel position or in a mutual substantially parallel position.

Furthermore, within a particular bundle the filaments are in a predominantly parallel position.

With a mutual parallel or mutual substantially parallel position of the bundles is meant that the main axis of the bundles are parallel or substantially parallel to each other.

With “substantially parallel” is meant that there may be some deviation from the mutual parallel position. However, if there is deviation, the deviation from the parallel position is small, i.e. less than 5 degrees and more preferably less than 3 degrees or even less than 1.5 degrees.

For the purpose of this invention “bundle” is defined as a group of n filaments, more particularly n metal filaments, whereby the n filaments are oriented predominantly parallel with the main axis of the bundle.

With “predominantly parallel” is meant that the filaments in a bundle are parallel or substantially parallel with the main axis of this bundle and remain parallel or substantially parallel with the main axis of this bundle over the major part of the length of the bundle.

At some cross-sections of a bundle a number of filaments may interchange position. However, once a number of filaments has interchanged position they are again oriented parallel or substantially parallel with the main axis of the bundle in such a way that over the major part of the length of the bundle the filaments are positioned parallel or substantially parallel with the main axis of the bundle.

Preferably, the filaments in a bundle are parallel or substantially parallel with the main axis of the bundle and the filaments remain parallel or substantially parallel with the main axis of the bundle over a length equal or larger than 20 times the diameter of the metal filaments, for example 23 times the diameter of the metal filaments.

More preferably, the filaments in a bundle are parallel or substantially parallel with the main axis of the bundle and the filaments remain parallel or substantially parallel with the main axis of the bundle over a length equal or larger than 50 times the diameter of the metal filaments, for example 100 times the diameter of the metal filaments.

According to the present invention the metal filaments of a bundle are in a predominantly parallel position. Furthermore, according to the present invention the metal filaments of a bundle remain in a predominantly parallel position in the textile structure and during use of this textile structure although the metal filaments are loosely associated and to some extent movable relative to each other.

The metal filaments of a bundle used in a textile structure according to the present invention are not twisted, cabled or bunched together.

Furthermore it is important to stress that all metal filaments present in the first direction of the textile structure according to the present invention are in mutual substantially parallel position without using wrapping filaments, i.e. an element that is wound helically around the metal filaments or without using a binding agent, i.e. an agent to bind the metal filaments of a bundle.

The predominantly parallel, loosely associated arrangement of the metal filaments in a bundle and in a textile structure made of such bundles allows easy infusion or penetration of the polymer material between the metal filaments of a bundle. This is a major advantage of a textile structure of the present invention over textile structures of the prior art comprising for example bundles that are twisted, cabled or bunched, or comprising bundles having a wrapping filament or comprising a binding agent.

As the bundles of metal filaments are mutual substantially parallel and as the metal filaments in a particular bundle are predominantly parallel with the main axis of the bundle, all metal filaments of the different bundles of a textile structure according to the present invention are mutual substantially parallel.

As all metal filaments present in the first direction of the textile structure are in mutual substantially parallel position, all metal filaments present in the first direction of the textile structure fully contribute to the strength of the structure. This is in contrast to textile structures comprising metal filaments known in the art such as textile structures comprising twisted filaments or filaments with a wrapping element, wherein not all filaments fully contribute to the strength of the textile structure.

The bundles present in the textile structure according to the present invention comprise n metal filaments, with n ranging between 2 and 85, more preferably between 5 and 21, as for example 6, 12 or 14.

The different bundles present in the textile structure according to the present invention may comprise the same number of metal filaments. Alternatively, the textile structure according to the present invention may comprise different bundles having a different number of filaments.

The different bundles present in the textile structure according to the present invention may have the same or a similar cross-section. Alternatively, the textile structure according to the present invention may comprise different bundles having different cross-sections.

According to the present invention the bundles have a non-circular cross-section, preferably a non-circular, convex cross-section.

With “convex” cross-section is meant a cross-section having a shape that curves or bulges outward.

As non-circular cross-section any cross-section that is not circular can be considered. Preferred cross-sections are flattened cross-sections, oval cross-sections, elliptic cross-sections, rectangular cross-sections and rhomboidal cross-sections.

In case the bundles have a flattened, oval or elliptic cross-section, the ratio of the height H of the bundle over the width W of the bundle is lower than 1, preferably lower than 0.79 or even lower than 0.66.

By using bundles having non-circular, flattened or oval cross-sections, the packing density in a stack of different textile structures is considerably increased.

To determine the cross-section of a bundle of filaments and to determine the height H and width W of a bundle, a textile structure according to the present invention is embedded in a polymer material such as a thermosetting polymer material and a cross-section is examined for example by optical microscopy.

A more detailed method to determine the cross-section, the height H and the width W of a bundle of filaments comprises the following steps
positioning the textile structure to be examined in a holder. The textile structured is for example clamped in a holder so that the textile structure may hang under its own weight.
embedding part of the textile structure in a polymer by dipping a certain length of the textile structure in a bath comprising a polymer such as a bath comprising a thermosetting resin. The length of the textile structure that is dipped in the bath is for example 2 cm. In a preferred method the textile structure is dipped in a bath comprising polyethylene glycol.
after solidifying, examining the cross-section of the textile structure embedded in the polymer for example by optical microscopy. It may be preferred to cut the solidified polymer for example at half height or to grind the solidified polymer to obtain an optimal cross-section for further examination.

Preferably, the different bundles present in the first direction of the textile structure according to the present invention are located in one plane.

As specified above, the metal filaments of a bundle are predominantly parallel. In preferred embodiments of textile structures according to the present invention, the textile structure comprises at least one bundle of n metal filaments wherein in at least one cross-section of this bundle m metal filaments interchange position.

However, it is clear that the n filaments of the bundle remain predominantly parallel with the main axis of the bundle over the length of the bundle.

The number m is higher than or equal to 2. Preferably, the number is lower than n as it is not preferred that all filaments of a bundle change position at the same time in the same cross-section of the bundle.

An advantage of having bundles wherein a number of m filaments interchange position in at least one cross-section of the bundle is that long line contacts between neighboring filaments are avoided. This positively influences the infusion or penetration of the polymer material in the bundle, i.e. between the metal filaments of the bundle.

It is possible that all bundles present in a textile structure have a number of m filaments that interchange position in at least one cross-section of the bundles. However, it is also possible that only one bundle or only a few bundles of the textile structure have a number of m filaments that interchange position in at least one cross-section.

In case more than one bundle comprises filaments that interchange position, the number m can be the same or can be different for the different bundles.

The number of filaments m that interchange position can be constant over the length of the bundle, i.e. constant in the different cross-sections wherein m filaments interchange position or the number of filaments m may vary over the length of the bundle.

In case a number of m filaments of a bundle interchange position in different cross-sections of a bundle, preferably the m filaments interchange position at irregular intervals over the length of the bundle.

Metal Filaments

Any metal can be used to provide the metal filaments. Preferably, the metal filaments comprise steel filaments. The steel may comprise for example high carbon steel alloys, low carbon steel alloys or stainless steel alloys.

The metal filaments have a diameter preferably ranging between 0.04 and 1 mm. More preferably, the diameter of the metal filaments ranges between 0.07 and 0.75 mm, as for example 0.10 or 0.21 mm.

All metal filaments of a bundle may have the same diameter. Alternatively, a bundle may comprise metal filaments having different diameters.

The metal filaments preferably have a circular cross-section although metal filaments with other cross-sections, such as flattened metal filaments or metal filaments having a square or rectangular cross-section can be considered as well.

The metal filaments can be uncoated or can be coated with a suitable coating, for example a coating giving corrosion protection or a coating guaranteeing adequate adhesion between the metal filament and the polymer material.

Suitable coating comprise zinc or zinc alloy coatings, for example zinc brass coatings, zinc aluminum coatings or zinc aluminum magnesium coatings. A further suitable zinc alloy coating is an alloy comprising 2 to 10% Al and 0.1 to 0.4% of a rare earth element such as La and/or Ce.

For a person skilled in the art it is clear that a coating such as a coating giving corrosion protection or a coating guaranteeing adequate adhesion between the metal filament and the polymer material can be applied on the filaments. However, it is also possible that a coating is applied on a bundle of metal filaments. The loose arrangement of the metal filaments in a bundle are advantageous for the penetration of the coating in the bundle, i.e. between the different metal filaments of a bundle.

Elongated Positioning Elements

As elongated positioning elements any elements suitable of holding the metal filaments of a bundle in a substantially parallel position can be considered, metallic positioning elements as well as non-metallic positioning elements.

Preferably, the elongated positioning elements comprise non-metallic elongated positioning elements. Examples of non-metallic elongated positioning elements comprise polymer filaments or polymer yarns, such as polyester filaments or polyester yarn. Particular examples comprise monofilaments of high modulus low shrinkage polyester having a diameter of 0.2 mm, spun yarns of 220 dtex or combinations thereof. A further example comprises multifilament yarns of 167 dtex.

Also glass filaments of glass yarn can be considered.

Preferably, the amount of elongated positioning elements present in a textile structure according to the present invention is less than 5 vol % of the textile structure. More preferably, the amount of elongated positioning elements is less than 3 vol % or less than 2 vol % of the textile structure. In some embodiments the amount of elongated positioning elements is less than 1 vol %, for example less than 0.5 vol %.

The amount of elongated positioning elements is expressed in vol % and corresponds with the volume occupied by the elongated positioning elements in a textile structure of a particular length divided by the volume occupied by the textile structure of this particular length, multiplied by 100. The volume occupied by the textile structure corresponds with the total volume of the textile structure, i.e. the sum of the volume occupied by the metal filaments of the bundles, the volume occupied by the elongated positioning elements and in case other elements such as binding wrap filaments are present in the textile structure, the volume occupied by this other elements.

As the amount of elongated positioning elements present in a textile structure according to the present invention is less than 5 vol % of the textile structure, respectively less than 3 vol % or less than 2 vol %, the amount of bundles (and thus the amount of parallel metal filaments) in the first direction of the textile structure can be higher than 95 vol % (=100−5 vol %), respectively higher than 97 vol % (=100−3 vol %) or higher than 98 vol % (=100−2 vol %) of the textile structure.

The volume percentage of metal filaments in a textile structure according to the present invention is much higher than in case of a textile structure comprising bundles with a wrapping filament. As an example if a wrapping filament of 0.1 mm is wrapped around a bundle of 7 filaments having a diameter of 0.21 mm, the volume percentage of non parallel metal filaments is increased with at least 3 vol %. In case a wrapping filament of 0.1 mm is wrapped around a bundle of 12 filaments having a diameter of 0.21 mm, the volume percentage of non parallel metal filaments is increased with 1.8 vol %.

In preferred embodiments the bundles are present in a first direction of the textile structure whereas the positioning elements are present in a second direction of the textile structure.

The textile structure according to the present invention may for example comprise woven or knitted structures.

Examples of woven structures comprise woven structures wherein the bundles are present in the warp direction and the positioning elements are present in the weft direction.

Alternative examples of woven structures comprise woven structures wherein the bundles are present in the weft direction and the positioning elements are present in the warp direction.

For the woven structures different weaving techniques as well as different weave patterns can be considered.

The woven structures can be different in weaving technique as well as in weave pattern. The woven structure is for example a structure wherein the bundles of filaments are connected through a plain weave pattern or a satin type pattern. The woven structures may have patterns with a full selvedge. Alternatively band weave type structure can be considered. A particular example comprises a satin type pattern to connect the bundles on a loom where specific selvedges are designed to obtain good handling and transition to the other parts of the reinforced structure.

Preferred knitted structures are warp knitted structures.

Polymer Material

The polymer material may be a thermoplastic or a thermosetting polymer material.

With thermoplastic material is meant any thermoplastic or elastomeric polymer. Examples of suitable thermoplastic materials are: polyethylene (PE), polypropylene (PP), polystyrene (PS), polyethylene terephthalate (PET), polyethylene napthalate (PEN), polybutylene terephthalate (PBT), polyvinylchloride (PVC), polyester, polyamide (PA), polyimide (PI), polycarbonate (PC), styrene acrylonitrile (SAN), acrylonitrile-butadiene-styrene (ABS), thermoplastic polyurethane (TPU), thermoplastic polyolefins (TPO), thermoplastic copolyetheresters, anionic polyamide (APA), copolymers of these polymers or similar materials. Example of suitable thermosetting polymer material comprise epoxy, (unsaturated) polyester, vinylester, polyurethane and copolymers thereof.

According to a second aspect of the present invention a method of manufacturing a textile structure for the reinforcement of a polymer material is provided.

The method comprises the steps of
introducing a number of bundles of n metal filaments in mutual substantially parallel position in a machine to manufacture a textile structure. Each of the bundles have a main axis;
manufacturing a textile structure thereby using elongated positioning elements to hold the bundles in mutual substantially parallel position in said structure and to hold said n metal filaments of a particular bundle predominantly parallel with the main axis of said bundle.

The n metal filaments of the bundles introduced in the machine to manufacture a textile structure are not twisted, cabled or bunched. Furthermore the bundles of n metal filaments do not comprise a wrapping filament or a binding agent.

While introducing the bundles in the machine to manufacture a textile structure, the n metal filaments the n metal filaments of a bundle are predominantly parallel with the main axis of a bundle.

The machine to manufacture a textile structure may comprise a weaving machine or a knitting machine such as a warp knitting machine.

In case the method of manufacturing comprises weaving, the bundles of substantially parallel filaments can be fed into the weaving machine as the warp or as the weft. In a preferred method the bundles are fed into the weaving machine as the warp. The drawing in of the bundles is for example done in the heddles and in the reed, according to the suited weaving pattern and the selected bundling. By inserting the weft, the elongated positioning element is placed, the shed is closed and the new shed is opened, in which the next weft pick is inserted.

In case of knitting, the bundles of predominantly parallel filaments can for example be fed in the warp direction into a warp knitting machine. The bundles of metal filaments are thereby preferably placed between the stitching needles. As the stich bar is moving according to a selected pattern, the bundles of metal filaments can be connected by the stich material. The stitch material is thereby forming the elongated positioning elements of the knitted structure.

According to a third aspect of the present invention the use of a textile structure for the reinforcement of a polymer material is provided. Textile structures as described above are in particular suitable for the reinforcement of structural parts requiring high tensile strength and high compressive strength. Textile structures according to the present invention are for example suitable for the reinforcement of wind turbine blades or for the reinforcement of impact sensitive parts like impact beams for automotive applications.

The reinforced articles are for example obtained by vacuum infusion, vacuum assisted resin transfer molding, resin transfer moulding, prepreg moulding, extrusion, pultrusion, injection moulding, resin injection moulding or by any other technique known in the art.

### BRIEF DESCRIPTION OF FIGURES IN THE DRAWINGS

The invention will now be described into more detail with reference to the accompanying drawings wherein

FIG. 1 is a schematic illustration of a first embodiment of a textile structure according to the present invention;

FIG. 2 shows a typical cross-section of a bundle present in the textile structure shown in FIG. 1;

FIG. 3 is a schematic illustration of a second embodiment of a textile structure according to the present invention;

FIG. 4 is a schematic illustration of a third embodiment of a textile structure according to the present invention.

### MODE(S) FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

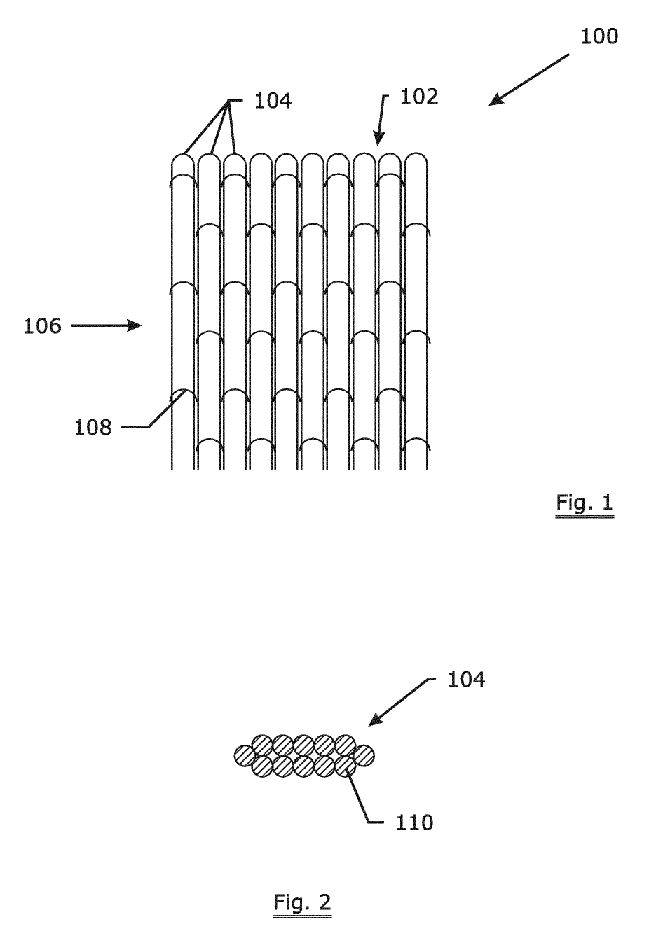

FIG. 1 is a schematic illustration of a textile structure 100 according to the present invention. The textile structure 100 comprises a woven structure having in warp direction 102 a number of bundles 104. Each bundle 102 comprises 12 steel filaments 110 having a diameter of 0.21 mm.

The weft direction 106 comprises polyamide monofilaments (70 tex) 108.

The fraction of monofilaments present in textile structure 100 is about 2 vol %.

The textile structure 100 has a plain weave pattern.

The textile structure 100 shown in FIG. 1 has a thickness of 0.58 mm.

FIG. 2 shows a possible cross-section of a bundle 104 present in the textile structure 100 shown in FIG. 1. The bundle 104 comprises 12 steel filaments 110. The bundle has a flattened cross-section.

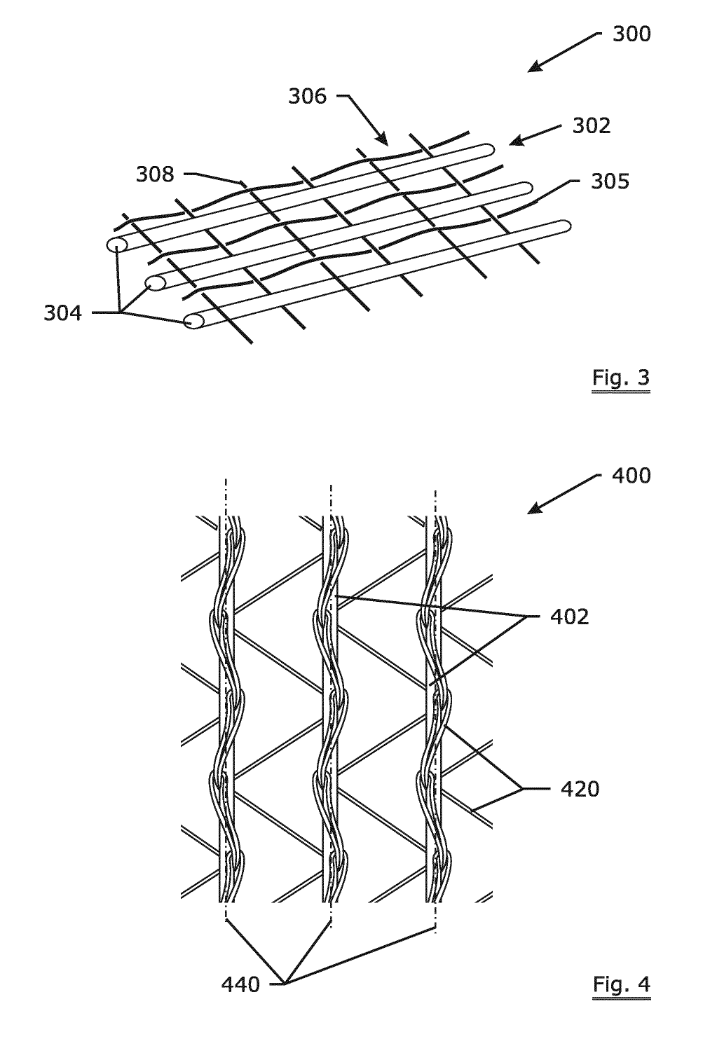

FIG. 3 shows a further embodiment of a textile structure 300 according to the present invention. The textile structure 300 comprises a woven structure having in warp direction 302 a number of bundles 304. Each bundle 304 comprises 12 steel filaments 310. The warp direction 302 further comprises a binding warp filament 305 between two bundles 304 of steel filaments. The weft direction 306 comprises the elongated positioning element. The fraction of the non-steel filaments present in textile structure 300 is 3.8 vol %.

FIG. 4 shows a knitted structure 400. The knitted structure 400 comprises in a number of bundles 402 arranged in mutual substantially parallel position.

In the knitted structures the bundles 402 are worked into the loop of the stitches 420 at the stitch line 440. The textile stitches shown in this example are in a tricot configuration.

1-10. (canceled)

11. A textile structure for the reinforcement of a polymer material, said structure comprising in a first direction a number of bundles arranged in mutual substantially parallel position,
said bundles comprising n metal filaments, said bundles having a main axis and a non-circular cross-section,
for each of said bundles said n metal filaments of a particular bundle being arranged predominantly parallel with the main axis of said particular bundle, said structure further comprising elongated positioning elements to hold said bundles in mutual substantially parallel position and to hold said n metal filaments of a particular bundle predominantly parallel with the main axis of said bundle.

12. A textile structure according to claim 11, wherein said bundles consist of n metal filaments, said n metal filaments being not twisted, cabled or bunched together.

13. A textile structure according to claim 11, wherein the cross-sections of said bundles are flattened, oval, elliptic, rectangular or rhomboidal cross-sections.

14. A textile structure according to claim 11, wherein said textile structure comprises at least one bundle of n metal filaments, wherein in at least one cross-section of said at least one bundle a number of m metal filaments interchange position, said n metal filaments of said bundle thereby maintaining said predominantly parallel position with said main axis of said bundle.

15. A textile structure according to claim 14, wherein m is higher than or equal to 2 and lower than n.

16. A textile structure according to claim 11, wherein the amount of elongated positioning elements present in said textile structure is less than 5 vol % of said textile structure.

17. A textile structure according to claim 11, wherein said structure is a woven structure.

18. A textile structure according to claim 11, wherein said structure is knitted structure.

19. A method of manufacturing a textile structure as defined in claim 11, said method comprising the steps of
introducing a number of bundles of n metal filaments in mutual substantially parallel position in a machine to manufacture a textile structure, each of said bundles having a main axis;
manufacturing a textile structure thereby using elongated elements to hold the bundles in mutual substantially parallel position in said structure and to hold said n metal filaments of a particular bundle predominantly parallel with the main axis of said bundle.

20. The use of a textile structure as defined in claim 11 for the reinforcement of a polymer material.
